(19) United States
(12) Patent Application Publication
(10) Pub. No.: US 2001/0042018 A1
(43) Pub. Date: Nov. 15, 2001

(54) Bi-directional broadcasting and delivering system

(76) Inventor: Takahiro Koga, Tokyo (JP)

Correspondence Address: McGuire Woods, Suite 1800, 1750 Tysons Boulavard, Tysons Corner, McLean, VA, 22102-4215, US

(21) Appl. No.: 09/851,977

(22) Filed: May 10, 2001

(30) Foreign Application Priority Data
May 12, 2000 (JP) 144637/2000

(51) Int. Cl. G06F 17/60

(52) U.S. Cl. 705/14; 705/10

(57) ABSTRACT

A bi-directional type broadcasting and delivery system includes an advertiser system of an advertiser, an advertising agent system of an advertising agent, a broadcasting station system of a broadcasting station, a user terminal of a user, and a service system which are connected to a network. The advertiser determines policy data for an advertisement program, and transmits the policy data and a demand of production of an advertisement program of articles of the advertiser from the advertiser system to the advertising agent system. The advertising agent produces the advertisement program based on the poly data in response to the demand of production of the advertisement program, and the advertising agent system transmits the advertisement program and the policy data to the broadcasting station system. The broadcasting station system broadcasts the advertisement program. The user terminal receives the advertisement program from the broadcasting station system and displays the received advertisement program, wherein a user selects a specific one of the articles in which the user has interest when the user views the received advertisement program on the user terminal, the selection being informed to the service system with a user ID. The service system prepares a private page for the user based on detailed data of the specific article and the user ID. The user terminal downloads and displays the private page from the service system, and the user transmits an instruction for purchase or reservation of the specific article from the user terminal to the service system.

### BACKGROUND OF THE INVENTION

1. Field of the Invention

The present invention relates to a bi-directional broadcasting and delivering system and method in which an article is purchased through broadcasting and a network.

2. Description of the Related Art

A conventional commercial broadcasting and delivering method is known in which online shopping and questionnaire of an article are carried out using a satellite broadcasting and a network. In this conventional method, advertisement is carried out to a user through the satellite broadcasting and the reaction of the user to the advertisement can be acquired through the network.

FIG. 1 shows the conventional advertisement broadcasting and delivering system. In FIG. 1, the conventional broadcasting and delivering system is composed of a user terminal 240, a broadcasting station system 230, a network 300 connected to them mutually, and a satellite 260.

An advertiser requests an advertising agency to advertise articles, and the advertising agency produces an advertisement program and transmits the produced advertisement program to the broadcasting station and requests the broadcasting of this advertisement program. The broadcasting station broadcasts the requested advertisement program to the user terminal 240 through the satellite 260 using the broadcasting station system 230.

The user of the user terminal 240 hears and views the received advertisement program. If having an interest in the article shown in the advertisement program, the user calls a dealer who sells the article, and carries out online shopping through the network 300 connected with the user terminal 240. Or, the user actually goes to a shop to purchase or reserve for the purchase. At this time, the advertisement program contents viewed and heard by the user are uniform irrespective of the attribute data such as the sexuality and age of the user.

However, there are the following problems in this conventional advertisement broadcasting and delivering system. First, advertisement effectivity data such as data indicating that the user has viewed the advertisement program or data indicating the user has wanted to view the advertisement program are not correctly managed and measured.

Also, the advertisement effectivity data are not fed back to the advertisement program contents in real time. For this reason, it is difficult to optimize the advertisement program contents or sales promotion contents such as a discount amount and a giveaway about the data of the purchase layer, customer, the time or the time zone in real time.

### SUMMARY OF THE INVENTION

Therefore, an object of the present invention is to provide a bi-directional type broadcasting and delivering system and method in which an advertisement program can be broadcast and the reaction of a user to the advertisement program can be fed back.

Also, another object of the present invention is to provide a bi-directional type broadcasting and delivering system and method in which the above sales promotion contents can be optimized in real time.

In an aspect of the present invention, a bi-directional type broadcasting and delivery method is attained by (a) broadcasting a program including an advertisement program of articles from a broadcasting station system to a user terminal, the advertisement program being produced by an advertising agent in response to a demand transmitted by an advertiser from an advertiser system to an advertising agent system; by (b) selecting on the user terminal, a specific one of the articles in which a user has interest when the user views the advertisement program on the user terminal; by (c) informing the selection to a service system through a network with a user ID; by (d) preparing a private page for the user based on detailed data of the specific article and the user ID; by (e) downloading the private page from the service system to the user terminal through the network; and by (f) carrying out purchase or reservation of the specific article on the user terminal on which the detailed data of the specific article is displayed.

The bi-directional type broadcasting and delivery method may further include the steps of: (g) transmitting policy data for the advertisement program determined by the advertiser from the advertiser system to the advertising agent system and demanding production of the advertisement program to the advertising agent, the policy data being transmitted from the advertising agent system to the service system, and (h) demanding the broadcasting of the advertisement program produced by the advertising agent based on the policy data, from the advertising agent system to the broadcasting station system.

In this case, the bi-directional type broadcasting and delivery method may further include the step of: (i) paying an advertisement production fee from the advertiser to the advertising agent; and (j) paying a broadcasting fee from the advertising agent to a broadcast company.

Also, the bi-directional type broadcasting and delivery method may further include the step of: (j) charging a fee to the advertiser system by the service system for every transaction of the (c) informing step.

Also, the (d) preparing step may be attained by (k) determining the detailed data of the specific article based on policy data. In this case, the policy data may be predetermined by the advertiser.

Also, the bi-directional type broadcasting and delivery method may further include the step of: (l) charging a fee to the advertiser system by the service system for every transaction of the (k) determining step.

Also, the (k) determining step may be attained by (m) determining the detailed data of the specific article based on the policy data, and at least one of customer data of the user and season and time data at the selection.

Also, the bi-directional type broadcasting and delivery method may further include the steps of: (n) producing marketing data by the service system based on the purchase or reservation of the specific article; and (o) transmitting the marketing data from the service system to at least one of the advertiser system, the advertising agent system and the broadcasting station system. In this case, the policy data may be optimized based on the transmitted marketing data in the at least one of the advertiser system, the advertising agent system and the broadcasting station system to update the policy data of the service system.

Also, the (b) selecting step may be attained by (q) recording an ID of a guide program for the advertisement program in the user terminal by selecting the advertisement program. Also, the (c) informing step may be attained by (r) starting the guide program on the user terminal; by (s) transmitting the guide program ID and the user ID from the user terminal to the service system; and by (t) managing the user ID and the guide program ID as a database.

Also, in another aspect of the present invention, a bi-directional type broadcasting and delivery system includes an advertiser system of an advertiser, an advertising agent system of an advertising agent, a broadcasting station system of a broadcasting station, a user terminal of a user, and a service system which are connected to a network. The advertiser determines policy data for an advertisement program, and transmits the policy data and a demand of production of an advertisement program of articles of the advertiser from the advertiser system to the advertising agent system. The advertising agent produces the advertisement program based on the poly data in response to the demand of production of the advertisement program, and the advertising agent system transmits the advertisement program and the policy data to the broadcasting station system. The broadcasting station system broadcasts the advertisement program. The user terminal receives the advertisement program from the broadcasting station system and displays the received advertisement program, wherein a user selects a specific one of the articles in which the user has interest when the user views the received advertisement program on the user terminal, the selection being informed to the service system with a user ID. The service system prepares a private page for the user based on detailed data of the specific article and the user ID. The user terminal downloads and displays the private page from the service system, and the user transmits an instruction for purchase or reservation of the specific article from the user terminal to the service system.

Here, the advertiser system may pay an advertisement production fee to the advertising agent system, and the advertising agent system may pay a broadcasting fee to the broadcast company.

Also, the service system may charge a fee to the advertiser system by the service system each time the selection is informed to the service system.

Also, the service system may determine the detailed data of the specific article based on the policy data. In this case, the service system may charge a fee to the advertiser system each time the detailed data is determined. Also, the service system may determine the detailed data of the specific article based on the policy data, and at least one of customer data of the user and season and time data at the selection.

Also, the service system may produce marketing data based on the purchase or reservation of the specific article, and transmits the marketing data to at least one of the advertiser system, the advertising agent system and the broadcasting station system.

Also, the policy data may be optimized based on the transmitted marketing data in the at least one of the advertiser system, the advertising agent system and the broadcasting station system to update the policy data of the service system.

Also, an ID of a guide program for the advertisement program may be recorded in the user terminal in response to the selection of the advertisement program, and the user terminal may start to display the guide program, and transmits the guide program ID and the user ID to the service system. In this case, the service system manages the user ID and the guide program ID as a database.

### BRIEF DESCRIPTION OF THE DRAWINGS

FIG. 1 is a block diagram showing a conventional advertisement broadcasting and delivering system;

FIG. 2 is a block diagram showing a bi-directional type broadcasting and delivering system according to an embodiment of the present invention;

FIGS. 3A to 3C are sequence diagrams showing the operation of the bi-directional type broadcasting and delivering system according to the embodiment of the present invention;

FIG. 4 is a diagram showing an example of TV advertisement and a multifunction icon displayed on a display screen of a user terminal;

FIG. 5 is a diagram showing an example of the top page of a private page displayed on the display screen of the user terminal; and

FIG. 6 is a diagram showing an example of detailed data contents of the private page displayed on the display screen of the user terminal.

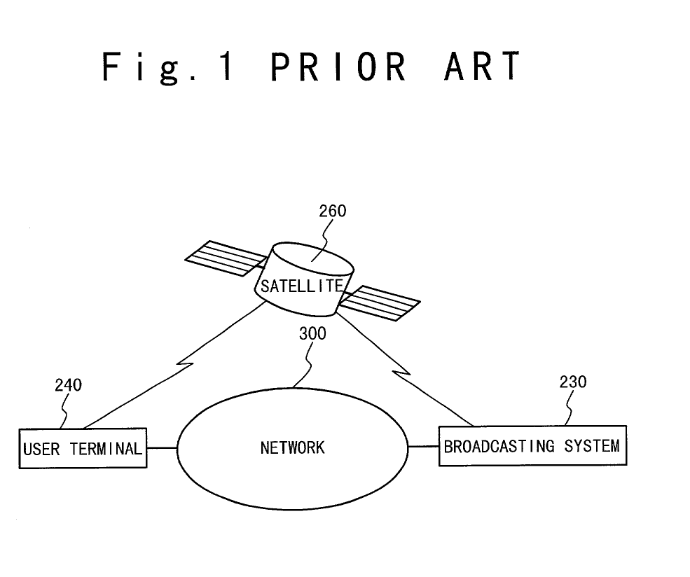

### DESCRIPTION OF THE PREFERRED EMBODIMENTS

Hereinafter, a bi-directional type broadcasting and delivering system of the present invention will be described with the attached drawings.

In the bi-directional type broadcasting and delivering business system according to an embodiment of the present invention, advertisement effectivity data such as the data indicative that a viewer has viewed an advertisement program and the data indicating that the viewer has wanted to view the advertisement program are accumulated in a server on a network. Also, the advertisement effectivity data can be fed back to the advertisement contents.

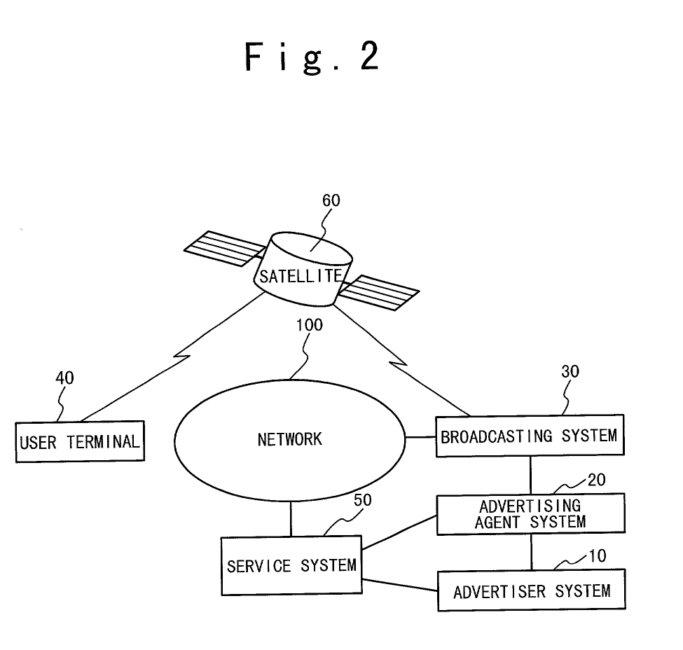

FIG. 2 is a block diagram showing a bi-directional type broadcasting and delivering system according to this embodiment of the present invention. Referring to FIG. 2, the bi-directional type broadcasting and delivering system according to this embodiment is composed of an advertiser system 10 of an advertiser, an advertising agent system 20 of an advertising agent, a broadcasting station system 30 of a broadcasting station, a user terminal 40 of a user, a network such as the Internet, and a satellite 60.

The advertiser system 10 transmits policy data to an advertising agency system 20. The policy data is used to determine the contents of detailed data to be downloaded by the user.

The advertising agency system 20 transmits the policy data and an ID of the policy data through a network 100 to the service system 50, which is composed of a server and a database. The advertising agency produces an advertisement program for sales promotion using a guide menu program in response to a request or demand from the advertiser. The guide menu program is also referred to as a multifunction icon in the present invention. The advertising agency system 20 requests the broadcasting station system 30 to broadcast and deliver the produced advertisement program for the sales promotion.

The broadcasting station system 30 broadcasts and delivers a program produced by the broadcasting station and containing the advertisement program for the sales promotion through the satellite 60 in response to the request from the advertising agency system 20 together with a program data of the multifunction icon.

The user terminal 40 receives the program containing the advertisement program from the broadcasting station system 30 to display them on the display screen. The user selects a “selection” button of the multifunction icon on the display screen. As a result, the selection of the multifunction icon is recorded in the user terminal 40, and in the service system 50 through the network 100.

In a home page for the exclusive use to the user (hereinafter, to be referred to as a private page), it is possible to operate the multifunction icon on the user terminal 40. When the private page is started at an optional time, the user terminal 40 transmits the user ID to the service system 50 through the network 100. Also, the user terminal 40 transmits the multifunction icon ID to the user terminal 40. Thus, the service system 50 can recognize the guide menu program or multifunction icon stored in the user terminal.

Next, the user terminal 40 downloads the private page for the exclusive use to the user from the service system 50 and displays the private page on the screen. At this time, the service system 50 manages the user ID and the multifunction icon ID from the user terminal 40 in the form of a database.

Next, the user operates the multifunction icon on the private page of the user terminal 40 to select a menu item, and the user terminal 40 transmits an ID of the selected menu item and the user ID to the service system 50 through the network 100.

The service system 50 receives the selected menu item ID of the multifunction icon and the user ID, from the user terminal 40, and refers to the policy data received from the broadcasting station system 30, the advertising agency system 20 or the advertiser system 10 to determine the contents of the detailed data. The service system 50 prepares the user exclusive use private page in accordance with the contents of the determined detailed data. The user terminal 40 downloads this detailed data from the service system 50 through the network 100 and displays the downloaded private page on the screen. For example, the user specifies reservations of the desired articles through the screen.

The service system 50 carries out a reservation process specified by the user and transmits additional data related to the articles to the user terminal 40 for a new business chance.

The service system 50 transmits the advertisement effectivity data as marketing data to the broadcasting station system 30, the advertising agency system 20, or the advertiser system 10.

The advertising agent system 20 feeds back the marketing data received from the service system 50 into the contents of the advertisement program, resets the contents of the policy data and optimizes them for update.

The advertiser system 10 feeds back the marketing data received from the service system 50 into the policy data of the advertisement, resets the contents of the policy data of the advertisement and optimizes them for update.

Next, the more detailed structure of the system will be described.

The advertiser system 10 has a function to transmit to the advertising agency system 20 and the service system 50, policy data which is used to determine the advertisement program and sales promotion contents for the detailed data of the articles. That is, the sales promotion contents are such as a discount amount and a giveaway. Thus, the policy data may contains the proceeds and the profitability, each user personal data such as customer layer data and customer data, and external data such as a season and a time zones and every combination of them.

The advertising agency system 20 has a function to allocate a policy ID to the policy data received from the advertiser system 10, and to transmit the policy data and the policy ID to the service system 50. Also, the advertising agency produces the advertisement program for sales promotion using the guide menu program in response to a request from the advertiser system 10. The advertising agency system 20 has a function to transmit the advertisement program for sales promotion to the broadcasting station system 30.

The broadcasting station system 30 allocates a policy ID to the policy data of the program produced by the broadcasting station, and transmits the policy data and the policy ID to the service system 50. Also, the broadcasting station system 30 broadcasts the program produced by the broadcasting station and the advertisement program produced by the advertising agency system 20 to a plurality of the user terminals 40 through the satellite 60.

The user terminal 40 displays the program and the advertisement program received from the satellite 60 on the screen, and records the guide menu program corresponding to the advertisement program in which the user has an interest. The user terminal 40 displays the exclusive use private page on the user terminal 40 by selecting a button of the multifunction icon as the guide menu program on the display screen.

Also, the user terminal 40 transmit the user ID and an ID of the selected guide menu program to the to the service system 50 through the network 100 when the user starts up the private page.

Moreover, the user terminal 40 downloads the detailed data corresponding to the selected guide menu program from the service system 50 to display on the screen.

The service system 50 allocates the user ID to personal data registered by the user to receive the service according to this embodiment. Also, the service system 50 registers this user ID and the corresponding customer data on the service system 50. Then, the service system 50 provides the user through the network 100 with service such as an e-mail function of free communication charge through the network 100, prize application in TV in one-click, purchase of the articles, a data request and reservation, after this use registration.

Also, the service system 50 manages as a database the data relating to all menu item IDs of the guide menu program recorded into the user terminal 40 and the user IDs, and searches the customer data corresponding to the user ID based on the user ID and the menu item ID received from the user terminal 40. Also, the service system 50 determines the contents of the detailed data to be downloaded by the user terminal 40 while referring to the policy data received from the advertiser system 10, by handling this customer data, the user ID, the menu item ID and external data such as the season, times and time zones. The service system 50 allocates a detailed data ID to the contents of the determined detailed data, and manages this detailed data ID, the corresponding menu item ID and the user ID. The service system 50 arranges the contents corresponding to the detailed data ID on the private page for the user exclusive use on the service system 50. The contents contain, for example, software parts of the detailed data such as a button in which a discount amount is mentioned in case of the advertisement program for the sales promotion and a button in which giveaway contents are mentioned.

Moreover, the service system 50 manages the number of times of view of the detailed data by the user through the network 100, the number of times of the reservation and secret customer data such as the age, sexuality, area and occupation. Therefore, the service system 50 transmits the correlation of the number of times of views of the detailed data, the number of the times of the reservation, the secret customer data and the policy data as the advertisement effectivity data or marketing data to the broadcasting station system 30, the advertising agency system 20 or the advertiser system 10.

Moreover, the service system 50 carries out an accounting operation every transaction process which accompanies the provision of the function of the service system 50 to the user or the use system.

Next, the operation of this embodiment will be described in detail.

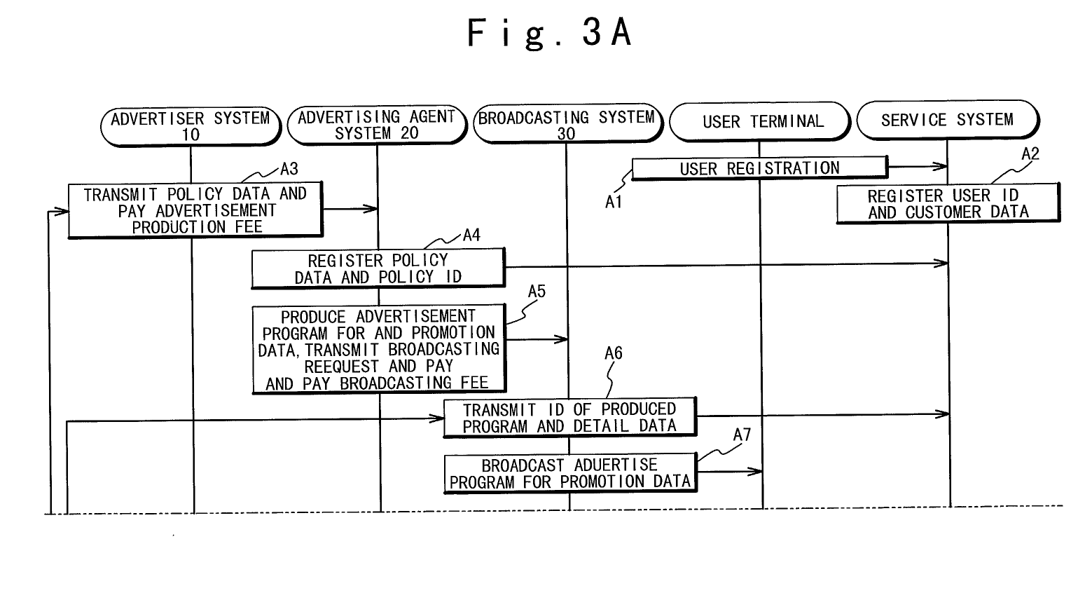

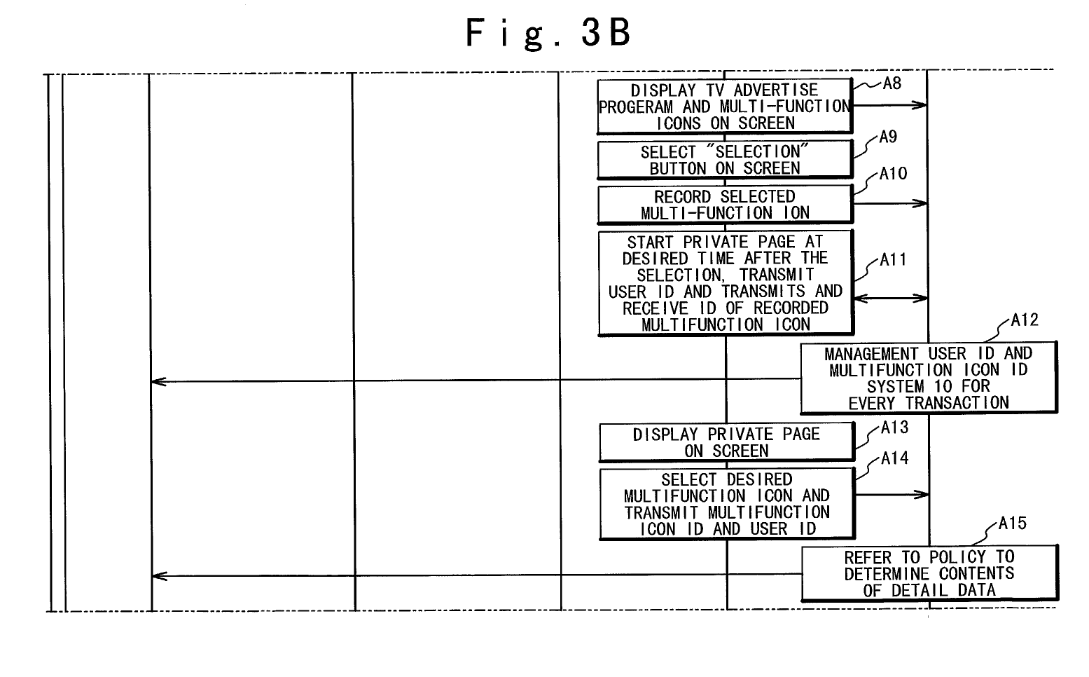

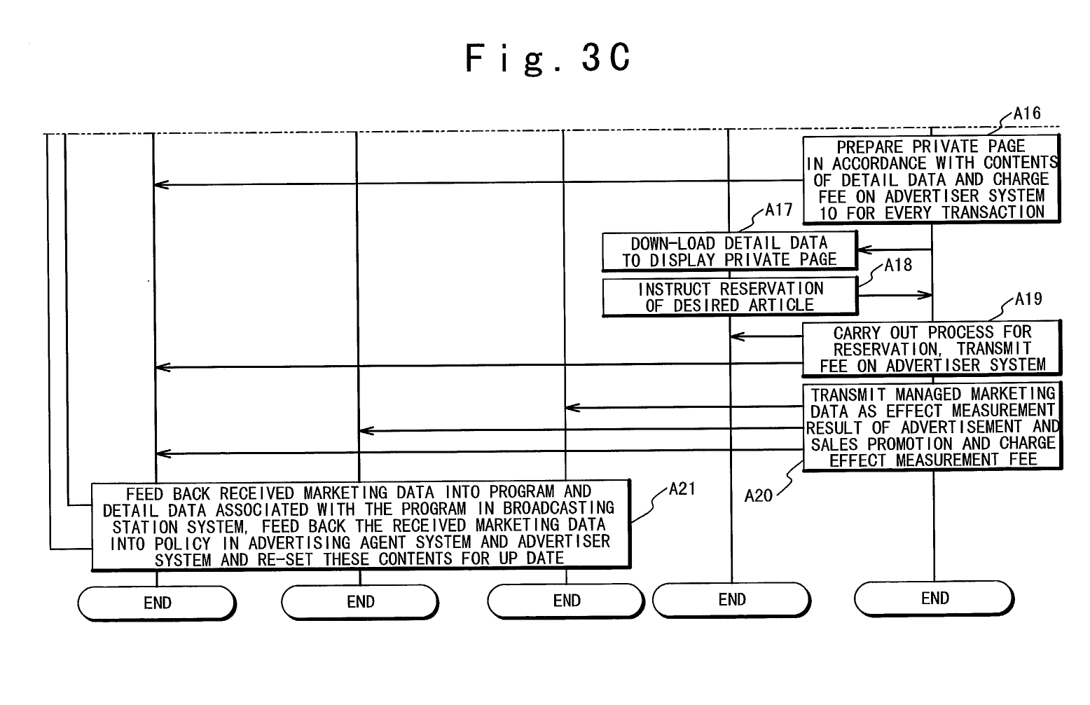

Referring to FIGS. 3A to 3C, a user previously carries out free charge use registration of the customer data such as the address, name and birthday of the user to a service provision company, and the service system 50 allocates the user ID to this customer data for the service use by the user (step A1). This user ID and the corresponding customer data are registered on the service system 50 connected with the network 100 (Step A2).

After this use registration, the user can receive the service such as the free charge communication charge e-mail function through the network 100, the prize application in the TV, the purchase of the articles, the data request, and the reservations with one-click.

Next, the advertiser system 10 determines the policy data and transmits it to the advertising agency system 20 to increase the proceeds and the profitability. The policy data is used to determine the advertisement program for sales promotion contents about the detailed data of the articles, i.e., contents such as the discount amount and the giveaways every customer layer data, customer data and external data such as the season, the times and the time zone, or every combination of them. The advertiser system 10 requests to produce the advertisement program for sales promotion to the advertising agency system 20, and the advertiser system 10 transmits the policy data determined finally to the advertising agency system 20, and pays the advertising agency an advertisement producing fee (Step A3).

The advertising agency system 20 allocates the policy ID to the policy data received from the advertiser system 10, and transmits the policy data and the policy ID to the service system 50 and registers them (Step A4).

The advertising agency produces the advertisement program for the sales promotion by himself or an external manufacturer based on the policy data and the guide menu program in advertising agency system 20 in response to the request from the advertiser. The advertising agency system 20 transmits the advertisement program for sales promotion to the broadcasting station system 30, carries out the request of the broadcasting delivery to the broadcasting station system 30, and the advertising agency system 20 pays the broadcasting station system 30 the broadcasting delivery fee (Step A5).

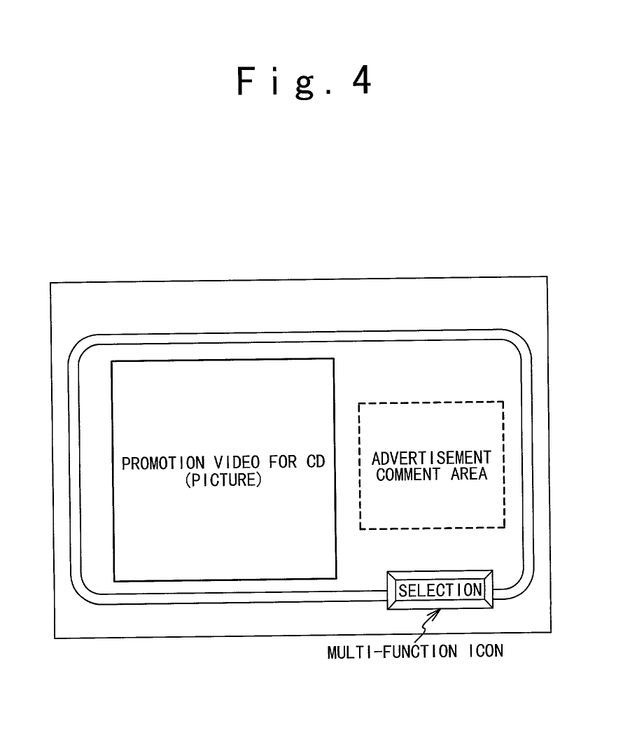

The broadcasting station system 30 allocates IDs to the program and the detailed data produced by the broadcasting station and the advertisement program, transmits the program ID, the advertisement program ID and the detailed data to the service system 50 and registers them (Step A6). Then, the broadcasting station system 30 carries out the broadcasting delivery through the satellite 60, the program produced by the broadcasting station together with the advertisement program for sales promotion received from the advertising agency system 20 (Step A7). At this time, the advertisement program for sales promotion is displayed on the display screen of the user terminal 40 as shown in FIG. 4 (Step A8).

In this case, it is supposed that the user terminal 40 is a satellite broadcasting TV receiver, for example. However, the user terminal 40 is not limited to this. In the example of FIG. 4, the user hears and views the TV advertisement program of the musical CD.

The user who has seen the TV advertisement and has had an interest in a specific one of the articles, selects a “selection” button on the display screen by pushing a determination key of the TV remote control (step A9). The guide menu program corresponding to the TV advertisement program in which the user has an interest is recorded to the private page of the user terminal 40 and the corresponding guide menu program (multifunction icon) ID is transmitted through the network 100 to the service system 50 (Step A10).

The user turns on the power of the user terminal 40 at an optional time later to start the private page for viewing the guide menu program, and the user terminal 40 transmits the user ID to the service system 50. Also, the user terminal 40 exchanges the recorded guide menu program ID with the service systems 50. In this way, the coincidence is established between the guide menu program recorded to the private page in the user terminal 40 and the guide menu program recorded on the private page for the user exclusive use in the service system 50 (Step A11).

The service system 50 manages as a database, the data relating to all guide menu program (multifunction icon) IDs recorded on the user terminal 40 and the user IDs, and carries out an accounting operation to the advertiser system 10 every transaction process as the function rental charge of the guide menu program (Step A12).

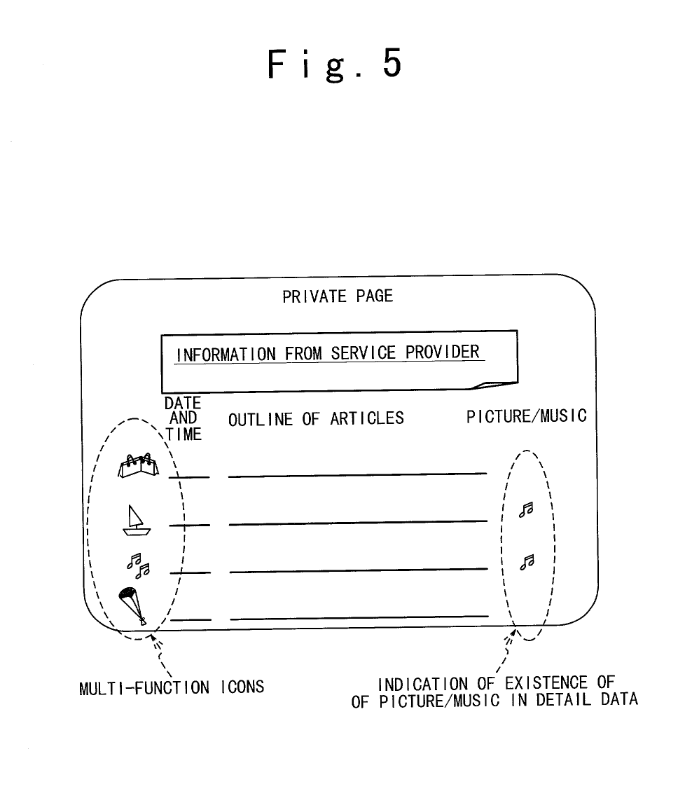

After the coincidence is taken between the user terminal 40 and the service system 50, the top page of the private page as shown in FIG. 5 is displayed on the display screen of the user terminal 40 together with the multifunction icon recorded in the past, the multifunction icon recorded at step A11 and the other service menu (Step A13).

The user selects the multifunction icon which has data of the desired articles from the top page (FIG. 4) of the private page, and transmits the user ID and the menu item ID corresponding to this multifunction icon to the service system 50 from the user terminal 40 (Step A14).

The service system 50 first searches the customer data corresponding to the user ID based on the received user ID and the menu item ID, and determines the contents of the detailed data which the user terminal 40 will download while referring to the policy determined by the advertiser using this customer data, the user ID, the menu item ID and external data such as the season, times and the time zone as input data (Step A15). Next, the service system 50 allocates a detailed data ID to the contents of the determined detailed data and manages the detailed data ID, the corresponding menu item ID and the user ID.

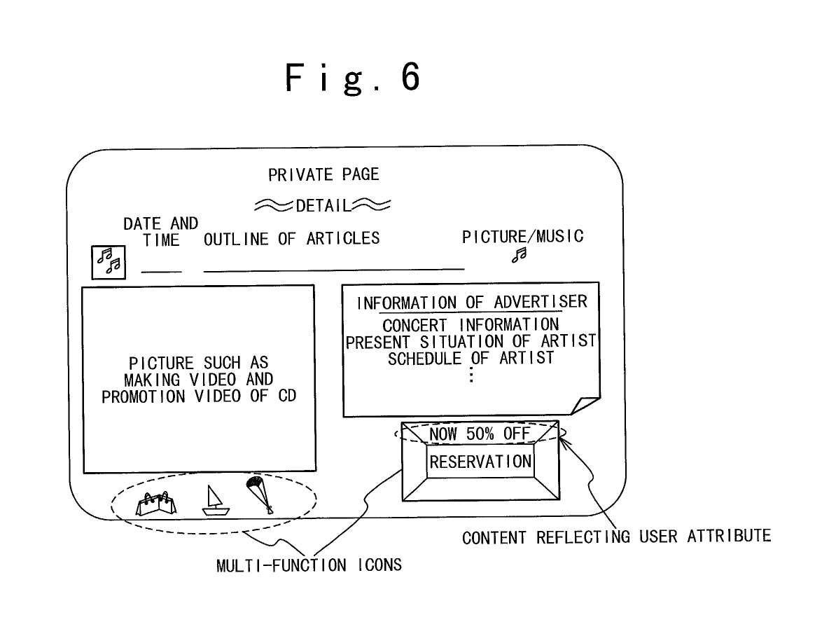

The service system 50 displays on the screen of the private page for the user exclusive use, the detailed data in the service system 50, the software parts of the detailed data such as a button in which the discount amount corresponding to the detailed data ID is mentioned and a button in which giveaway contents are mentioned, as shown in FIG. 6. Moreover, the service system 50 carries out an accounting operation to the advertiser system 10 as the rental charge of the detailed data viewing function of the guide menu program (multifunction icon) every transaction processing (Step A16). In this case, when the detailed data that the user wants to view is the detailed data relating to the program produced by the broadcasting station, the accounting operation is carried out every transaction process to the broadcasting station as the rental charge of the detailed data reading function of the guide menu program (multifunction icon) in a step A16.

In this way, the user terminal 40 downloads, displays on the screen and views and hears the detailed data contents (FIG. 5) arranged in accordance with the customer data, the status data and the policy data (Step A17).

In this case, for example, in the view of the detailed data of the CD, it is possible to hear it. However, it is also possible to select a “reservation” button (the reservation of the CD in the case) of the private page as shown in FIG. 6, when the user has an interest in the article corresponding to the detailed data which the user has downloaded and to reserve the CD (step A18). For example, addition data service is carried out to transmit from the service system 50 to the user terminal 40 of the reserving person of the CD through the network 100, the multifunction icon to which the concert data of the same artist as this CD is added. The accounting operation is carried out to the advertiser system 10 as the contingent fee to these reservations (Step A19).

On some day or in real time, the service system 50 transmits to the broadcasting station system 30, the advertising agency system 20, the advertiser system 10 or all of them, the advertisement effectivity data such as data indicating that the viewer has viewed the advertisement program and the data indicating that the user wants to view it, for the marketing data provision service. Then, the service system 50 carries out an accounting operation to the broadcasting station system 30, the advertising agency system 20 or the advertiser system 10 as an effect measurement fee (Step A20).

The broadcasting station system 30 feeds back the marketing data received from the service system 50 to the contents of the program, and re-sets and optimizes the contents of the policy data of the detailed data about the program again for update. Also, the advertiser system 10 and the advertising agency system 20 feed back the marketing data received from the service system 50 to the policy data of the advertisement and re-sets and optimizes the contents of the policy of the advertisement again for update (Step A21). Then, once again, the steps from the step A3 are repeated.

As mentioned above, according to this embodiment, the policy data is optimized and updated for each of accesses such as the access to the broadcast program or advertisement program from the user, the access to request the detailed data, and the access for reservation, that is, in accordance with the measurement of the effect of the sales promotion. Therefore, the precision of the policy data about the user can be made high.

The first effect is in that the data about the view of the broadcast program or advertisement can be measured in real time without a privacy problem.

The reason is in that the data indicating that the viewer has viewed an program or advertisement provided for the viewer through the broadcasting or the data indicating that the user has wanted to view it is accumulated in real time on the server on the network and it is possible to process with secrecy.

The second effect is in that it is possible to optimize the sales promotion contents such as the contents of the broadcast program, the discount amount and the giveaway without the privacy problem based on the data such as the purchase layer, customer, the time and the time zone, so that the broadcasting station can increase an audience rate and the advertiser can increase the effect of the sales promotion of the articles and the sales promotion expenses can be reduced. The reason is in that the measurement result obtained in the above first effect is fed back to the program contents or the advertisement contents, so that the effect of the program or advertisement can be optimized.

What is claimed is:

1. A bi-directional type broadcasting and delivery method, comprising the steps of:
(a) broadcasting a program including an advertisement program of articles from a broadcasting system to a user terminal, said advertisement program being produced by an advertising agent in response to a demand transmitted by an advertiser from an advertiser system to an advertising agent system;
(b) selecting on said user terminal, a specific one of said articles in which a user has interest when said user views said advertisement program on said user terminal;
(c) informing said selection to a service system through a network with a user ID;
(d) preparing a private page for said user based on detailed data of said specific article and said user ID;
(e) downloading said private page from said service system to said user terminal through said network; and
(f) carrying out purchase or reservation of said specific article on said user terminal on which said detailed data of said specific article is displayed.

2. The bi-directional type broadcasting and delivery method according to claim 1, further comprising the steps of:
(g) transmitting policy data for said advertisement program determined by said advertiser from said advertiser system to said advertising agent system and demanding production of said advertisement program to said advertising agent, said policy data being transmitted from said advertising agent system to said service system, and
(h) demanding said broadcasting of said advertisement program produced by said advertising agent based on said policy data, from said advertising agent system to said broadcasting system.

3. The bi-directional type broadcasting and delivery method according to claim 2, further comprising the step of:
(i) paying an advertisement production fee from said advertiser to said advertising agent; and
(j) paying a broadcasting fee from said advertising agent to a broadcast company.

4. The bi-directional type broadcasting and delivery method according to claim 1, further comprising the step of:
(j) charging a fee to said advertiser system by said service system for every transaction of said (c) informing step.

5. The bi-directional type broadcasting and delivery method according to claim 1, wherein said (d) preparing step comprises the step of:
(k) determining said detailed data of said specific article based on policy data.

6. The bi-directional type broadcasting and delivery method according to claim 5, wherein said policy data is predetermined by said advertiser.

7. The bi-directional type broadcasting and delivery method according to claim 5, further comprising the step of:
(l) charging a fee to said advertiser system by said service system for every transaction of said (k) determining step.

8. The bi-directional type broadcasting and delivery method according to claim 5, wherein said (k) determining step comprises the step of:
(m) determining said detailed data of said specific article based on said policy data, and at least one of customer data of said user and season and time data at said selection.

9. The bi-directional type broadcasting and delivery method according to claim 1, further comprising the steps of:
(n) producing marketing data by said service system based on said purchase or reservation of said specific article; and
(o) transmitting said marketing data from said service system to at least one of said advertiser system, said advertising agent system and said broadcasting system.

10. The bi-directional type broadcasting and delivery method according to claim 9, wherein said detailed data of said specific article is determined based on policy data, and
said method further comprises the steps of:
(p) optimizing said policy data based on said transmitted marketing data in said at least one of said advertiser system, said advertising agent system and said broadcasting system, to update said policy data of said service system.

11. The bi-directional type broadcasting and delivery method according to claim 1, wherein said (b) selecting step comprises the step of:
(q) recording an ID of a guide program for said advertisement program in said user terminal by selecting said advertisement program, and
said (c) informing step comprising the steps of:
(r) starting said guide program on said user terminal;
(s) transmitting said guide program ID and said user ID from said user terminal to said service system; and
(t) managing said user ID and said guide program ID as a database.

12. A bi-directional type broadcasting and delivery system, comprising an advertiser system of an advertiser, an advertising agent system of an advertising agent, a broadcasting system of a broadcasting company, a user terminal of a user, and a service system which are connected to a network,
wherein said advertiser determines policy data for an advertisement program, and transmits said policy data and a demand of production of an advertisement program of articles of said advertiser from said advertiser system to said advertising agent system,
said advertising agent produces said advertisement program based on said poly data in response to the demand of production of said advertisement program, and said advertising agent system transmits said advertisement program and said policy data to said broadcasting system,
said broadcasting system broadcasts said advertisement program,
said user terminal receives said advertisement program from said broadcasting system and displays said received advertisement program, wherein a user selects a specific one of said articles in which said user has interest when said user views said received advertisement program on said user terminal, the selection being informed to said service system with a user ID,
said service system prepares a private page for said user based on detailed data of said specific article and said user ID, and
said user terminal downloads and displays said private page from said service system, and said user transmits an instruction for purchase or reservation of said specific article from said user terminal to said service system.

13. The bi-directional type broadcasting and delivery system according to claim 12, wherein said advertiser system pays an advertisement production fee to said advertising agent system, and
said advertising agent system pays a broadcasting fee to said broadcast company.

14. The bi-directional type broadcasting and delivery system according to claim 12, wherein said service system charges a fee to said advertiser system by said service system each time said selection is informed to said service system.

15. The bi-directional type broadcasting and delivery system according to claim 12, wherein said service system determines said detailed data of said specific article based on said policy data.

16. The bi-directional type broadcasting and delivery system according to claim 15, wherein said service system charges a fee to said advertiser system each time said detailed data is determined.

17. The bi-directional type broadcasting and delivery system according to claim 15, wherein said service system determines said detailed data of said specific article based on said policy data, and at least one of customer data of said user and season and time data at said selection.

18. The bi-directional type broadcasting and delivery system according to claim 12, wherein said service system produces marketing data based on said purchase or reservation of said specific article, and transmits said marketing data to at least one of said advertiser system, said advertising agent system and said broadcasting system.

19. The bi-directional type broadcasting and delivery system according to claim 18, wherein said policy data is optimized based on said transmitted marketing data in said at least one of said advertiser system, said advertising agent system and said broadcasting system such that said policy data in said service system is updated.

20. The bi-directional type broadcasting and delivery system according to claim 12, wherein an ID of a guide program for said advertisement program is recorded in said user terminal in response to the selection of said advertisement program, and said user terminal starts to display said guide program and transmits said guide program ID and said user ID to said service system,
said service system manages said user ID and said guide program ID as a database.
